(19) United States
(12) Patent Application Publication
(10) Pub. No.: US 2021/0176919 A1
(43) Pub. Date: Jun. 17, 2021

(54) Field Cart

(71) Applicant: Stephen P. Hurley, Apollo Beach, FL (US)

(72) Inventor: Stephen P. Hurley, Apollo Beach, FL (US)

(21) Appl. No.: 17/124,630

(22) Filed: Dec. 17, 2020

Related U.S. Application Data
(60) Provisional application No. 62/948,975, filed on Dec. 17, 2019.

(51) Int. Cl. A01D 46/24; A01D 46/22; B62B 3/00; B62B 5/00

(52) U.S. Cl. CPC A01D 46/243; B62B 5/0013; B62B 3/005; A01D 46/22

(57) ABSTRACT

A field cart for using in a crop field having crop beds and furrows includes a base frame assembly having upper frames, lower frames, and connecting frames, which are arranged and connected between the upper frames and lower frames, and two or more wheels rotatably connected to the lower frames. The field cart further includes a chair and at least one tub attached to the upper frames. The chair and the tub are positioned at a same level in the field cart. The level of the chair and tub is higher than the depth of the furrow in the field.

### CROSS REFERENCE TO RELATED APPLICATION

This application claims the benefit of U.S. Provisional Application Ser. No. 62/948,975 filed Dec. 17, 2019, the disclosure of which is hereby incorporated herein by reference in its entirety.

### FIELD

The present disclosure relates to a planting or harvesting field cart.

### BACKGROUND

Harvesting strawberries involves back-breaking work. Typically, strawberry harvesting requires a worker to repeatedly bend, hunch, crouch, and stoop for extended periods of time as they inspect and harvest the low-lying strawberry fruit. Repetitive and extended periods in these unnatural and uncomfortable positions can, in turn, lead to knee, back, neck, shoulder and other health problems for the workers. Not only is harvesting strawberries agonizing and injurious at times, the harvesting process is time intensive, and thus costly.

In addition, current methods of harvesting strawberries are inefficient. Workers walk down furrows, harvest strawberries and place them in a container. After filling each container, they carry it to a collection point, drop it off and pick up another empty container. They must then walk the empty box back to where they left off, fill the box, and then return it to the collection point. Workers do this time and again throughout the day. As a result, workers have to travel long distance to reach roads to offload fruit-filled containers and subsequently collect empty containers to fill. Accordingly, the workers spend a significant portion of time moving containers to collection points, which is time that cannot be spent harvesting strawberries. The traveling of long distances causes workers to become tired, and eventually exhausted, thereby negatively affecting the speed of the crop harvesting.

Workers could use existing wheeled devices such as wheelbarrows, garden cars and the like, to assist in the strawberry picking. However, these devices suffer from a number of drawbacks. In particular, these devices do not work well in strawberry fields. In use, they do not resolve the drawbacks of manual, container harvesting. For example, they difficult to move and are readily bogged down in deep or sandy soil. Moreover, they do not eliminate the need for constant or frequent return trips to collections points.

Existing wheeled devices require the user to contort sideways within the cart to reach strawberries, and further contort to place the strawberries in their proper containers. Additionally, conventional wheeled devices have a propensity to drive over strawberry plants, thereby damaging the plants and fruit. Further, these conventional devices do nothing to establish a more healthy, more comfortable position, or reduce the amount of strain to the worker's body. In addition, the workers still spend a significant portion of their time for moving boxes back and forth between the picking point and the box collection point.

### SUMMARY

What is needed is a field cart that resolves or improves upon one or more of the foregoing drawbacks.

According to one aspect of the present disclosure, the field cart for using in a crop field having crop beds and furrows includes a base frame assembly having upper frames, lower frames, and connecting frames, which are arranged and connected between the upper frames and the lower frames, and two more wheels rotatably connected to the lower frame. The field cart further includes a chair attached to the upper frames, and the chair is positioned in the direction of the crop bed and perpendicular to a moving direction of the field cart along the furrow.

According to a further aspect of the present disclosure, the field cart may alternatively include a chair attached to the upper frames, the chair is positioned in the direction of the furrow and parallel to a moving direction of the field cart along the furrow. The field cart may move forwards or backwards in the furrow.

According to a further aspect of the present disclosure, the field cart includes at least one tub attached to the upper frames and positioned at a same level as a position of the chair. When two tubs can be attached on the upper frames, the chair is situated between the two tubs in a longitudinal direction. The connecting frames are configured to adjust a level of the upper frames according to a depth of the furrow in the crop field to avoid damaging of the crops. The position of the chair and tubs attached to the upper frames is higher than the depth of the furrow in the crop field so that the chair and tubs are positioned above the crop bed.

According to a further aspect of the present disclosure, the field cart includes a tub support frame configured to hold tubs. The field cart may also contain a securing bracket and a stability bracket coupled to the base frame assembly of the cart. The tub support frame, securing bracket, and stability bracket working together and configured to create a tub receiving area and frictionally hold tubs to the cart.

According to a further aspect of the present disclosure, a seatback portion of the chair is positioned above the crop bed for having a space in front of the chair inside the furrow.

According to a further aspect of the present disclosure, a wheel assembly includes a wheel member and two wheels rotatably connected to both ends of the wheel member such that a length of the wheel assembly in the lateral direction is less than a furrow width in the crop field. Due to the length of the wheel assembly, the wheels are maintained inside the furrow of the crop field when the field cart moves along a longitudinal direction. The length of the wheel assembly in the lateral direction is 16 inches.

According to a further aspect of the present disclosure, each of the wheels is formed of a solid type of tire for preventing a flat tire of the wheel.

According to a further aspect of the present disclosure, the field cart further includes a detacheable shade frame assembly having a shade fixing member and a shade. The shade is attached to a top frame of the shade fixing member for protecting a worker from the sunlight or the rain.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In the drawings,

FIG. 1 shows a top view of a strawberry field;

FIG. 2 shows a cross-sectional side view of the strawberry field of FIG. 1;

FIG. 3 shows a top view of a field cart in the strawberry field of FIG. 1;

FIG. 4 shows a side view of the field cart in the strawberry field of FIG. 2;

FIG. 5 shows a perspective front view of a field cart in accordance with an exemplary form of the present disclosure;

FIG. 6 shows a perspective rear view of the field cart of FIG. 5;

FIG. 7 shows a perspective side view of a base frame assembly of the field cart of FIG. 5;

FIG. 8 shows a perspective side view of the field cart of FIG. 5;

FIG. 9 shows a side view of an alternative embodiment of the field cart;

FIG. 10 shows a top view of the field cart of FIG. 9;

FIG. 11 shows a rear view of the field cart of FIG. 9;

FIG. 12 shows a side view of the field cart of FIG. 9 with a bin;

FIG. 13 shows a side view of a detachable shade;

FIG. 14 shows a top view of the detacheable shade of FIG. 13; and

FIG. 15 shows a rear view of the detacheable shade of FIG. 13.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

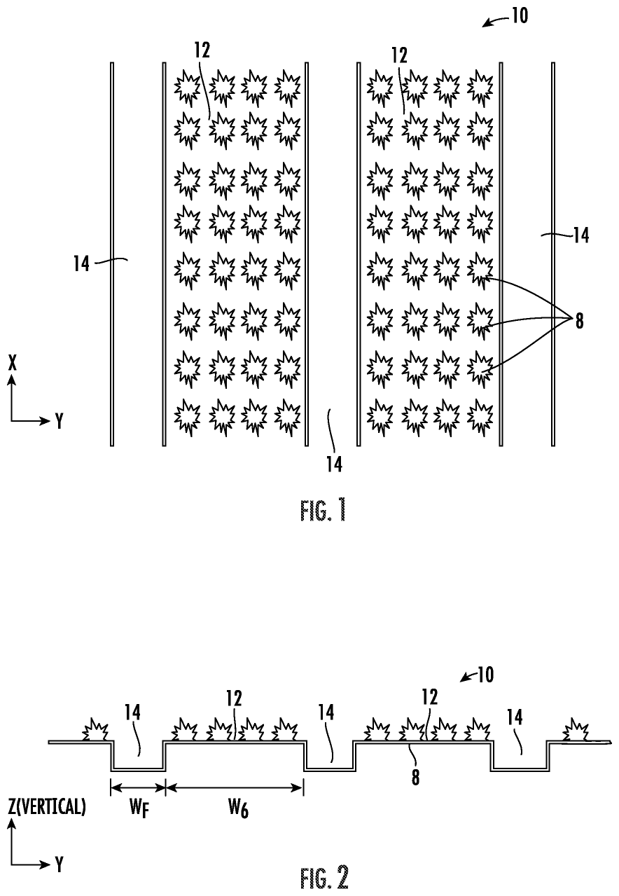

FIGS. 1 and 2 illustrate an example of a crop field such as a strawberry field 10. FIG. 1 shows a top view of the strawberry field 10, and FIG. 2 shows a side view of the strawberry field 10. The strawberry field 10 includes strawberry beds 12 for planting and growing strawberry plants 8 and furrows 14. However, while the strawberry plants and strawberry harvests are treated as exemplary, the embodiments described herein can be used for growing and harvesting numerous types of plants and fruits, especially ground level fruit.

As shown in FIGS. 1 and 2, the strawberry beds 12 include raised beds where the strawberry plants 8 are located. The raised strawberry beds 12 are protected because machines and people move through the furrows 14. The furrows 14 between the raised strawberry beds 12 include areas where no strawberry plants grow. The floor of the furrow 14 remains clear to permit passage of machines and/or people. In addition, a person or machine can be moved through the strawberry bed 12 with all parts in contact with the ground located on the floor of the furrow 14. Accordingly, the parts in contact with the ground (floor) do not damage the strawberry plants or the fruit growing on the strawberry bed 12.

FIG. 2 further shows a dimension of the strawberry field 10. The dimensions of the furrow width Wf and the strawberry bed width Wb can be standardized. The standardization may have any basis, including production efficiency, state or local regulations or any other basis. For example, as shown in FIG. 2, the furrow width Wf is approximately 18 inches, and the strawberry bed width Wb is approximately 48 inches. However, other dimensions of both the furrow width Wf and the strawberry bed width Wb may be implemented in accordance with other forms of the present disclosure. For example, another width of the strawberry beds 12 may be 24 inches according to the condition of the strawberry field 10.

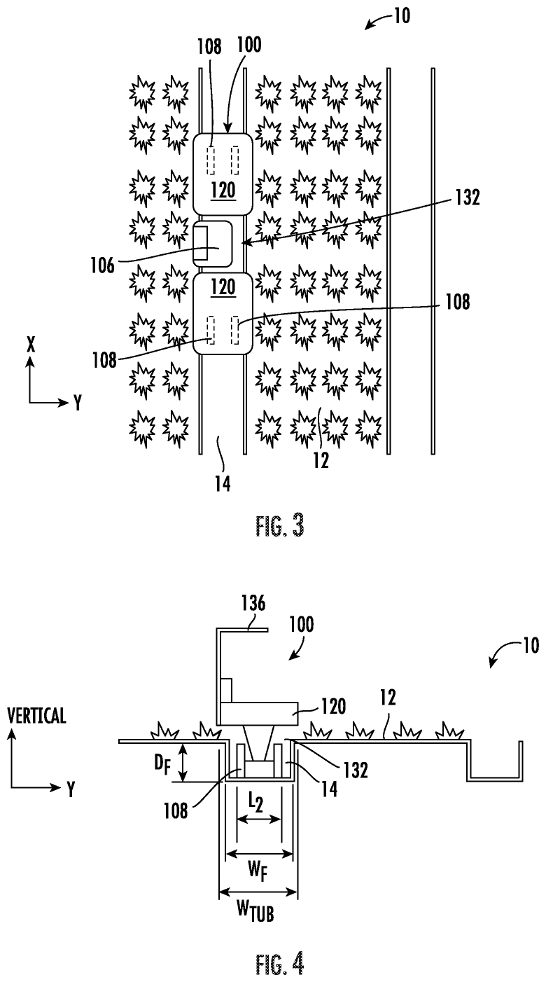

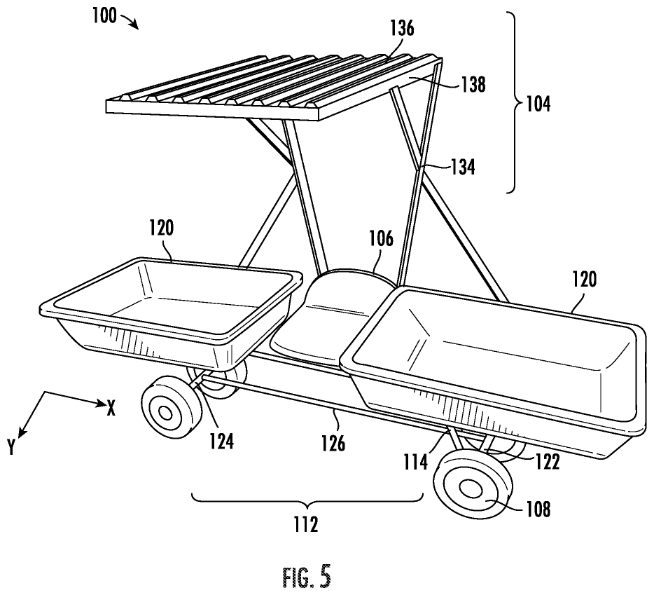

FIGS. 3 and 4 illustrate a field cart 100 for planting and harvesting the strawberry plants in the strawberry field 10. The field cart 100 is used to plant or harvest strawberries or other low-lying fruits. Generally, the field cart includes a laterally facing seat or chair 106, upper frame 110 and lower frame 112, an optional shade 136 (not shown in FIG. 3) and wheels 108. The field cart 100 allows the workers to plant and harvest strawberries while in a laterally-seated position, without being forced to stand and bend over. The field cart 100 further permits the user to drive or propel the field cart using the user's feet without the frame of the field cart interfering with normal lateral foot movement. This allows workers to comfortably and more ergonomically continue to harvest for long periods of time during a harvest day. As shown in FIGS. 3 and 4, accordingly, when the field cart 100 is used in the strawberry field 10, workers maintain reasonable posture without standing and bending-over, thereby reducing worker strain and discomfort. It also reduces the number of trips necessary for each worker since the field cart can contain far higher numbers of strawberries before it is necessary for the worker to need to drop off strawberries at collection points. Therefore, harvesting can be more productive and efficient by reducing time lost due to the workers' recovery from the strain and exertion.

FIGS. 5, 6, and 7 illustrate an example of the field cart 100. The field cart 100 includes a base frame assembly 102, a shade frame assembly 104, a chair 106, and wheels 108. The field cart 100 further includes one or more containers or tubs 120. The base frame assembly 102 includes upper frames 110, lower frames 112, and connecting frames 114. The upper frames 110 of the base frame assembly 102 further include a chair fixing member 116 and tub fixing members 118.

The chair fixing member 116 of the upper frames 110 secures the chair 106 and tub fixing members 118 secures the tubs 120. As shown in FIG. 5, the chair 106 and the tubs 120 are arranged along a longitudinal direction X, which is defined along a direction of the furrow 14 in the strawberry field 10. (See FIGS. 3 and 4). In FIG. 5, for example, the field cart 100 includes two tubs 120, and the chair 106 disposed between both the tubs 120 along the longitudinal direction X. Chair 106 is ideally offset (not centered over) the X-axis, thus providing movement room for the user. However, other arrangements of the chair 106 and the tubs 120 in accordance with other forms of the present disclosure may be implemented.

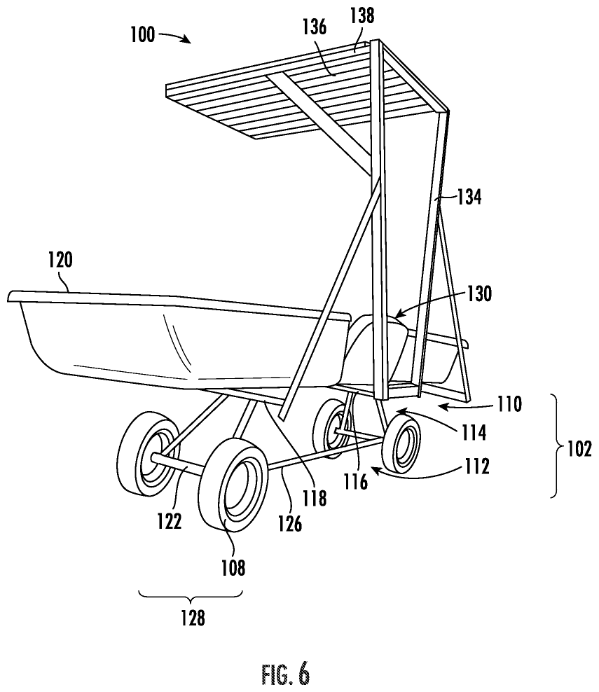

As illustrated in FIGS. 5-6, the lower frames include first and second axles 122 and 124, and a longitudinal connecting member 126 connected between the first and second axles 122 and 124 for securing the axles 122 and 124. The first and second axles 122 and 124 are parallel to each other and arranged along a lateral direction Y which is perpendicular to the longitudinal direction X. The wheels 108 are rotatably coupled to both ends of each of the axles 122 and 124. The longitudinal connecting member 126 disposed between the first and second axles 122 and 124 is perpendicularly connected to the axles 122 and 124 in the longitudinal direction X.

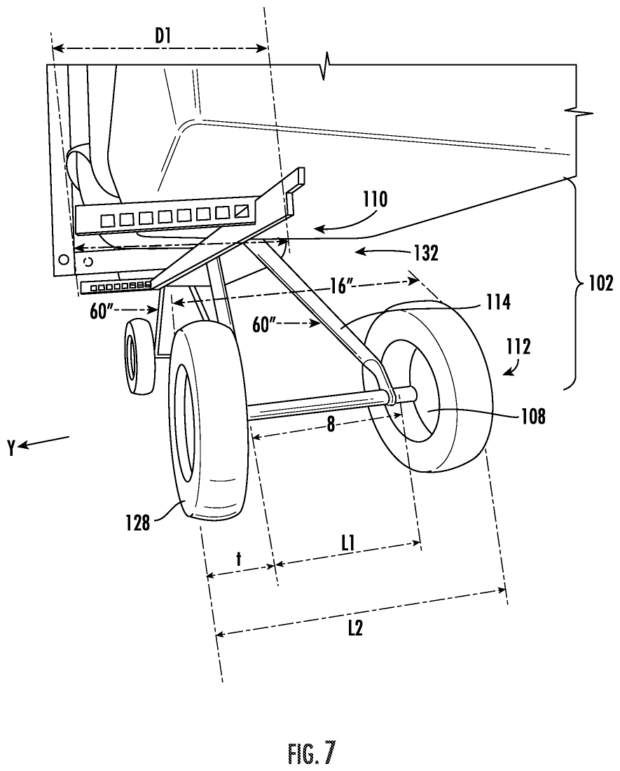

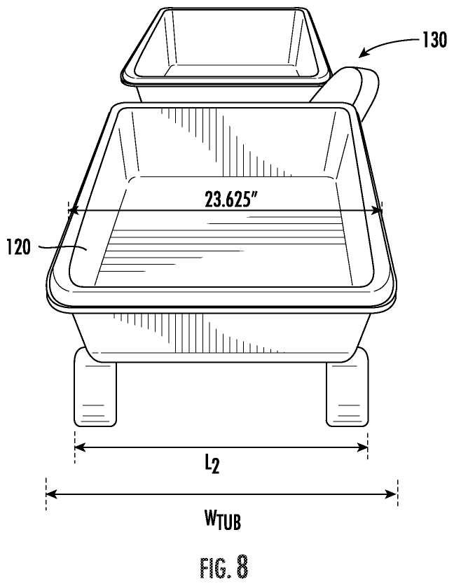

In FIGS. 4 and 7, for example, the wheels 108 can travel through the furrow 14 between the strawberry beds 12. As shown in FIG. 7, for example, a length L1 of each of the axles 122 and 124 is approximately 8 inches and the thickness t of each wheel 108 is approximately 4 inches. Accordingly, the total length L2 of a wheel assembly 128 in the lateral direction Y is approximately 16 inches. Since the furrow width Wf between the strawberry beds 12 is approximately 18 inches, the total length L2 of the wheel assembly 128 combined the length L1 of the respective axles 122 and 124 and the thickness t of each wheel 108 in the lateral direction Y is less than 18 inches (furrow width Wf). Accordingly, the dimension of the wheel assembly 128 allows the field cart 100 to move inside the furrow 14 without damaging the strawberry plants 8 on the strawberry beds 12, or the furrows 14 or getting hung up. However, other dimensions of the wheel assembly 128 in accordance with other forms of the present disclosure may be implemented for using in strawberry fields having a different Wf.

The wheels 108 of the field cart 100 each have a solid, treaded tire for allowing the field cart 100 to smoothly and efficiently operate in the strawberry field 10 with limited or no bogging down or deflating. The solid type tire of the wheels 108 effectively rolls inside the furrow 14 of the strawberry field 10 because of less deformation and stable operation of solid tires.

As shown in FIGS. 6 and 7, the plurality of connecting frames 114 are disposed and connected between the upper frames 110 and the lower frames 112. The dimensions and arrangement of the connecting frames 114 between the upper and lower frames 110 and 112 are determined according to an allowable height of the base frame assembly 102. For example, the height of the base frame assembly 102 including the wheels 108 may be greater than the depth Df of the furrow 14 so that the tubs 120 attached to the upper frames 110 are positioned above the strawberry beds 12 when the field cart 100 is moved through the furrow 14. Accordingly, the field cart 100 is moved inside the furrow 14 without damaging the strawberry plants on the strawberry beds 12, while providing sufficient room for the user's legs and feet to travel laterally when driving the field cart.

As shown in FIGS. 3, 4, and 6, the chair 106 is attached to the chair fixing members 116 and faced to the strawberry beds 12 in the lateral direction Y, which is perpendicular to the moving direction (longitudinal direction X) of the field cart 100 inside the furrow 14. Preferrably, the chair is offset from the centerline of the field cart. This offsets the user's center of gravity relative to the centerline and facilitates balancing of the user near the strawberries while working, and it provides added room to accommodate a user's legs and feet. Accordingly, when the field cart 100 is used in the strawberry field 10, the worker effectively harvests the strawberries while the worker is sitting on the chair 106. In this position, the worker can readily and rapidly fill the tubs without undue strain. When the worker completes the harvest of the strawberry at one location of the strawberry beds, the worker moves the field cart 100 with the worker's feet along the longitudinal direction X without standing or substantially changing his/her position. Accordingly, it is effective for the worker to use the field cart 100 when the strawberries are planted and harvested. In addition, one or more tubs 120 can be stacked. This reduces the need to continuously pick up tubs 120 on the way back from dropping off a single, full tub 120. As a result, the worker saves a significant portion of his/her time and energy moving the tubs 120 and effectively spends more time harvesting the strawberries in the field 10.

In accordance with other forms of the present disclosure, the field cart 100 may be automatically moved with an electric motor or an engine installed into the field cart 100. The installed electric motor or the engine drives the field cart 100 to move inside the furrow 14 with a low, constant or variable speed. In particular, the field cart 100 with the electric motor easily is operated by turning on/off switch or other drive controls. Accordingly, the field cart 100 with the automatic power driver (motor or engine) allows the worker to effectively harvest the strawberries in the field 10.

As shown in FIGS. 4 and 6, for example, the chair 106 is attached to the chair fixing member 116 of the upper frames 110 and positioned at a same level (height) as the tubs 120. When the field cart 100 moves inside the furrow 14, the attached chair 106 does not damage the strawberry plants on the beds 12 because a seatback portion 130 of the chair 106 is positioned over or beside the strawberry plants. For example, the seatback portion 130 of the chair 106 is laterally positioned beyond the upper frames 110 in the lateral direction Y so that the seatback portion 130 of the chair 106 is positioned above or beside the strawberry bed 12 because a space 132 is needed for placing the legs of the worker in front of the chair 106 inside the furrow 14. Accordingly, when the worker sits on the chair 106 for planting and harvesting in the field 10, the worker places his/her legs and feet in the limited space 132. (See FIG. 3). In FIGS. 3, 4 and 7, for example, a lateral distance D1 between the rearmost point (seatback) of the chair 106 and the middle line of the field cart 100 is approximately 16 inches along the lateral direction Y, so the worker places his/her legs and feet in the space 132 between the edge of the chair 106 and the edge line of the strawberry beds 12.

In FIGS. 3, 4 and 6, the tubs 120 are also positioned beyond the upper frames 110 and above the strawberry bed 12 in the lateral direction Y relative to the furrow 14. Depending on what works for the convenience of the worker, the field cart 100 may be used with smaller tubs, which have a dimension of 27.5 inches by 20 inches, or larger tubs, which have a dimension of 36 inches by 24 inches. For example, the present disclosure shows larger tubs 120. Irrespective of the tubs' size, however, the tubs 120 are positioned above the strawberry bed 12 because the tub width Wtub is greater than the furrow width Wf in the lateral direction Y. Accordingly, the attached tubs 120 on the upper frames 110 do not damage the strawberry plants when the field cart 100 moves inside the furrow 14.

As described above, the chair 106 is positioned between two tubs 120 for easily planting and harvesting the strawberries. During the planting season, for example, the worker sowing on the field cart 100 has plants in the tubs 120 on both sides and sow strawberry plants with pre-cut holes in the plastic covered “humps”. During the harvest season, the worker sitting on the chair 106 of the field cart 100 can maintain a strong, ergonomic posture while working quickly to inspect and pick the strawberries that are ripe and ready to be removed from the plants. With the tubs 120, the worker easily stores the strawberries and delivers the picked strawberries to the collection point.

In addition, the smaller tubs may be beneficial so that another worker collecting the tubs full of strawberries is better able to handle the tubs since it would be lighter than the larger tubs. In accordance with a form of the present disclosure, extra tubs nest, stack or rest in the exact same tub 120 that is attached to the upper frames 110 of the field cart 100. For example, the inner tubs for harvesting just nest inside the attached tub 120 and are simply lifted out when full, revealing an empty tub while the worker continues to pick the strawberries in the field 10.

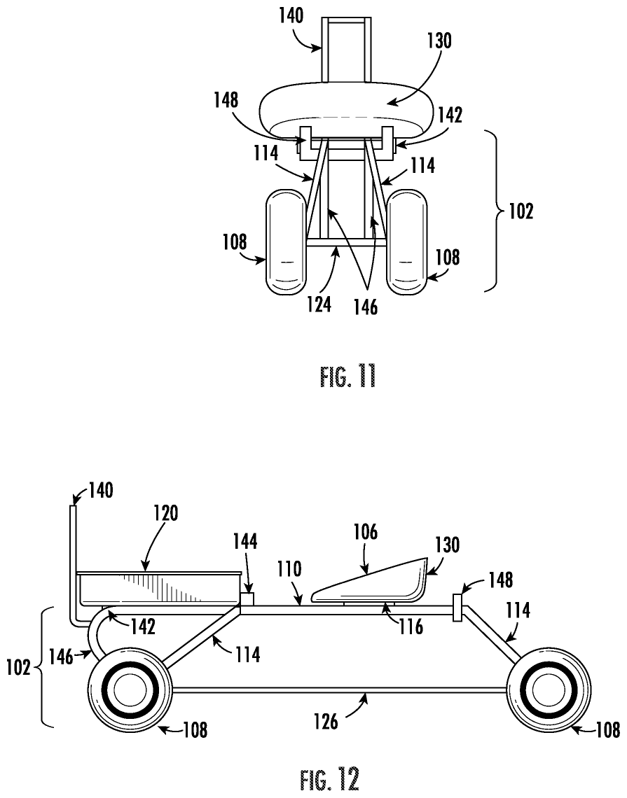

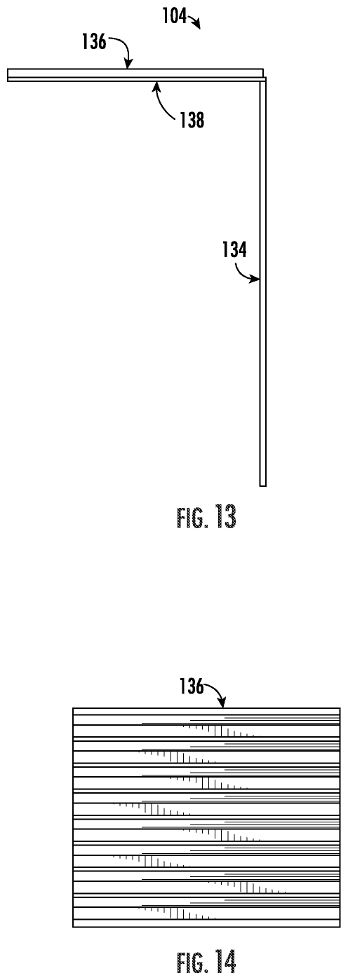

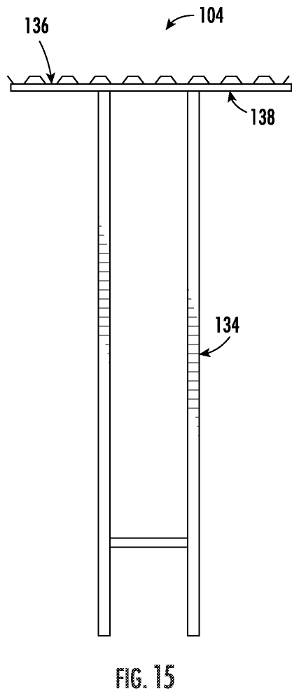

FIGS. 5 and 6 also show the shade frame assembly 104 installed in the field cart 100. FIGS. 13, 14, and 15 show only the shade frame assembly 104. The shade frame assembly 104 is detacheable and includes shade fixing members 134 vertically attached to the upper frames 110 of the base frame assembly 102 and a shade 136 attached to a top frame 138 of the shade fixing members 134. The shade 136 in the shade frame assembly 104 is configured to screen or protect the worker who is sitting on the chair 106 from the sunlight or the rain. The shade 136 that covers the worker is easily removable for transportation and storage purposes. In addition, the shade fixing members 134 attached to the upper frames 110 are configured to adjust according to the direction of the sunlight or rain, and also the height of the worker who is sitting on the chair 106. FIGS. 9, 10, and 11 show a field cart 100 with an accessory sleeve 148 coupled to the base frame assembly 102. The accessory sleeve is configured to couple with accessories. For example, in some embodiments the shade frame assembly 104 is coupled to the accessory sleeve 148.

FIGS. 9-12 show an alternative embodiment of the field cart 100 in which the chair 106 is configured in a longitudinal direction of travel. The chair 106 is attached to a chair fixing member 116 and faced to the longitudinal direction, which is parallel to the moving direction of the field cart 100 inside a furrow 14. In some embodiments the chair is offset from the center of the field cart so that the chair is closer to either the first axle 122 or the second axle 124. The offset chair may give the user room to accommodate their legs and feet for moving the cart, it may facilitate balancing of the user near the strawberries while working, it may facilitate balancing the weight of the tubs 120 to prevent the cart 100 from tipping, and it provides room for affixing tubs 120 to the cart for collecting strawberries. Accordingly, when the field cart 100 is used in the strawberry field 10, the worker effectively harvests the strawberries while the worker is sitting on the chair 106. In this embodiment with the chair 106 configured in a longitudinal direction, the worker may have the benefit of tubs 120 located directly in front of them for easier access with less strain. When the worker completes the harvest of the strawberries at one location of the strawberry beds 10, the worker manually moves the field cart 100 by the worker's feet along the longitudinal direction without standing or changing his/her position. The worker may move the cart in the direction they are facing by, for example, using their feet to walk the field cart 100 forward while the worker remains in their seated position. Alternatively, the worker may move the cart backwards, away from the direction they are facing, by, for example, using their feet to push the field cart 100 backwards while the worker remains in their seated position.

According to a further aspect, as shown in FIGS. 9-12, in some embodiments the field cart 100 is configured to hold and secure tubs 120 (FIG. 13). In such an embodiment, the base frame assembly 102 is modified to contain a tub support frame 146 that is located adjacent to the upper frames 110 and is connected to the upper frames 110 and the lower frame 112. The tub support frame 146 is dimensionally configured so that it is sized to hold tubs 120 placed on top of the tub support frame 146. In some embodiments the tub support frame 146 may contain a securing member 140; the securing member 140 preferably located distally away from the center of the cart 100 and the chair 106, and extending upwards. The securing member 140 may help secure tubs 120 from sliding off the cart 100. The securing member 140 may also facilitate stacking multiple tubs 120 on the cart to allow for more efficient harvesting of strawberries if the securing member 140 is tall enough to help support multiple stacked tubs 120.

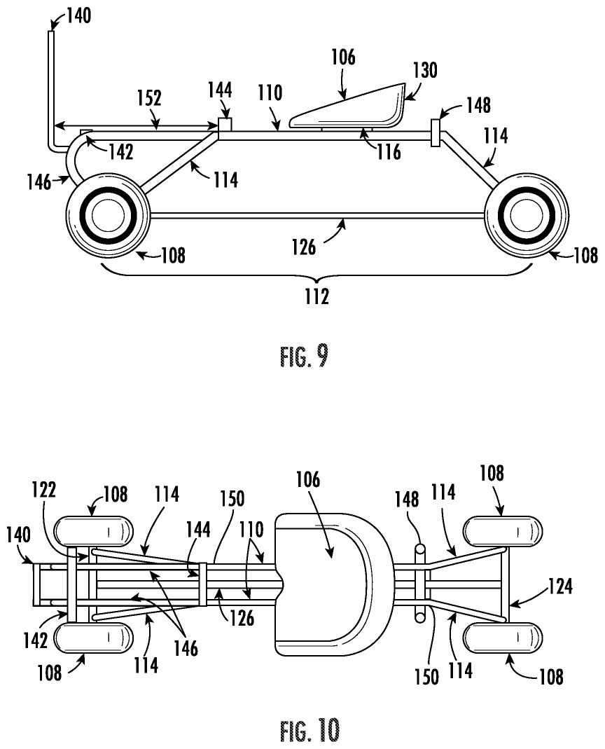

According to yet another aspect shown in FIGS. 9-12, in some embodiments the field cart 100 may include one or both of a securing bracket 144 and a stability bracket 142 coupled to the base frame assembly 102. For example, the securing bracket 144 and the stability bracket 142 may couple to the upper frames 110 or the tub support frame 146 of the base frame assembly 102. As shown in FIG. 9, the securing bracket 144 extends upwards from the base frame assembly 102 and in some embodiments is configured to work with the securing member 140 to create a tub receiving area 152. As shown in FIG. 12, the securing bracket 144 can be configured to frictionally hold a tub 120 in the tub receiving area 152 by having the securing bracket coupled to the base frame assembly 102 in a location that corresponds with the width or length of a tub 120. The stability bracket 142 may be used with the securing bracket 144 or by itself. FIG. 9 shows the stability bracket 144 coupled to the base frame assembly 102, preferably located between the securing member 140 and the securing bracket 144 and within the tub receiving area 152. The stability bracket 142 may extend outwards laterally from the base frame assembly 102 (e.g. FIG. 10). Accordingly, when a tub 120 is placed in the tub receiving area 152 (e.g. FIG. 12), the stability bracket 142 may provide lateral support to the tub 120, making it more difficult for the tub 120 to laterally fall off the cart 100.

As described above, due to the field cart 100 used in the strawberry field 10, the process of the sowing and harvesting the strawberry plants is effectively performed and is sped up so that labor cost is saved. The workers are less tired working in a sitting position while being shaded. Furthermore, the field cart allows workers to enjoy dramatically improved ergonomic conditions, thus limiting strains and injuries.

While the above description constitutes the preferred embodiments of the present invention, it will be appreciated that the invention is susceptible to modification, variation and change without departing from the proper scope and fair meaning of the accompanying claims.

What is claimed is:

1. A field cart, comprising:
a base frame assembly comprising an upper frame, a lower frame, a longitudinal connecting member and a connecting frame, the connecting frame arranged and connected between the upper frame and the lower frame;
axles connected to the lower frame;
the longitudinal connecting member connecting the axles;
wheels rotatably connected to the axles;
a chair attached to the upper frames in a position lateral to the direction of travel of the wheels;
the chair being offset from the longitudinal connecting member; and
a tub attached to the upper frame and positioned beside the chair.

2. The field cart of claim 1, further comprising a second tub positioned beside the chair, the second tub being attached to the upper frame.

3. The field cart of claim 2, wherein the connecting frame is configured to adjust a level of the upper frame according to a depth of the furrow in the crop field.

4. The field cart of claim 3, wherein the position of the chair and tubs attached to the upper frame is higher than the depth of the furrow in the crop field whereby the chair and tubs are positioned above the crop bed.

5. The field cart of claim 1, wherein a seatback portion of the chair is positioned on the upper frame, forming lateral foot space in front of the chair.

6. The field cart of claim 1, further comprising a wheel assembly having a wheel member, the wheel member having a first end and a second end, a wheel being rotatably connected to each end of the wheel member, and wherein the width of the wheel member is less than a standard-sized furrow width in a crop field.

7. The field cart of claim 6, wherein due to the length of the wheel assembly, the wheels are configured to fit within the furrow of a crop field.

8. The field cart of claim 7, wherein the length of the wheel assembly in the lateral direction is 16 inches.

9. The field cart of claim 1, wherein each of the wheels have a solid tire connected to the wheels.

10. The field cart of claim 1, wherein the field cart further includes a shade frame assembly having a shade fixing member removably attached to the upper frame, and a shade attached to the shade frame.

11. A field cart, comprising:
a base frame assembly, the base frame assembly, comprising:
a plurality of upper frames;
a lower frame having axles and a longitudinal connecting member, the longitudinal connecting member connecting the axles;
connecting frames arranged and connected between the upper frames and the lower frame;
a tub support frame, the tub support frame located adjacent to the upper frames and connected to the upper frames and the lower frame, the tub support frame including a securing member;
a stability bracket and a securing bracket, the stability bracket and the securing bracket coupled to the base frame assembly, the stability bracket and the securing bracket configured with the securing member to create a tub receiving area that frictionally fits a tub;
wheels rotatably connected to the axles; and
a chair coupled to the upper frames such that a seated user is facing the direction of travel of the cart.

12. The field cart of claim 11, further comprising an accessory sleeve coupled to the base frame assembly.

13. The field cart of claim 12, further comprising a shade frame assembly, the shade frame assembly including a shade and a shade fixing member, the shade fixing member including a top of frame, the shade attached to the top of frame, and the shade fixing member being configured to connect to the accessory sleeve.
